(19) United States
(12) Patent Application Publication
(10) Pub. No.: US 2006/0099564 A1
(43) Pub. Date: May 11, 2006

(54) Integrated external collaboration tools

(76) Inventors: Holger Bohle, Walldorf (DE); Martin Erhard, Karlsruhe (DE); Thomas Uhlig, Heidelberg (DE)

Correspondence Address: PERKINS COIE LLP, 101 JEFFERSON DR, PO BOX 2168, MENLO PARK, CA, 94025, US

(21) Appl. No.: 10/985,568

(22) Filed: Nov. 9, 2004

(51) Int. Cl. G09B 3/00

(52) U.S. Cl. 434/350

(57) ABSTRACT

The present embodiments provide a system and methods for allowing a user to interact with a learning management system. The user is able register, cancel or follow up with classes offered within the learning management system. For each user action there is a corresponding method that allows for links to be created between the user and the class. The links contain specific rules that may be determined by an administrator. The links further contain collaboration rooms and other tools based on the users status within the learning management system.

### CROSS-REFERENCE TO RELATED APPLICATION

None

### TECHNICAL FIELD

The present invention relates to learning management systems, and more particularly to a system and methods for providing user application tools and links between users and data objects within a learning management system catalog.

### BACKGROUND

Computerized learning systems, sometimes referred to as “tutorial”0 systems, have been around for many years. The earliest of tutorial systems were designed for mainframe computers. With the advent of personal computers in the mid to late 70's tutorial systems were increasingly available for home and office personal computer use. With the advent of personal computer networking, the market for the network-based learning systems blossomed.

For example, PLATO Learning Systems, currently having a website at the URL www.plato.com, began in 1963 with Control Data and University of Illinois using a grant from the National Science Foundation to develop technology and content for a mainframe computer based instructional system. In 1986 with the growth of personal computer technology, the PLATO courseware library and management systems were modified for delivery via local area networks. Starting in the 1990's the PLATO technology became available over wide area networks, such as the public wide area network commonly referred to as the Internet. When delivered over the Internet, courses are sometimes referred to as having “e-learning” content.

While the number of companies offering e-learning content is substantial, there are relatively fewer companies which are active in the business of creating tools for creating and managing e-learning content. SAP, for one, has been active in learning and e-learning technologies for a number of years.

Founded in 1972, SAP is a recognized leader in providing collaborative business solutions for all types of industries. SAP, headquartered in Walldorf Germany, is the world's largest enterprise software company. As such, a major focus of SAP's e-learning programs has been to provide powerful business oriented e-learning solutions to its core corporate customer base. More particularly, SAP provides a series of tools for authoring, managing and delivering e-learning content such that its customers can manage the entirety of the creative and administrative functions for a fully integrated e-learning system. These tools are generally referred to as Learning Management Systems (LMS).

A learning management system or training management system provides different ways to access its data. One approach is to support roles such as an administrator, a learner and an instructor. Customers want their LMS to be web enabled, where every role is represented by a web frontend or interface that may be accesses through a browser. Internet technology empowers not only the customer user to do their bookings in an employee self-service (ESS) scenario, it also drives the kind of training available to learners. In current SAP training and event management, only classroom trainings are available. With these solutions and its web interface called a learning portal, this is extended by new training forms based on Internet technology, such as web based trainings, computer based trainings, online test, virtual classroom etc. These training forms provide a human-to-computer interaction. But they do not support human-to-human interactions like instructors or virtual learning groups.

Learning Management Systems may provide single or multiple training catalogs. Training catalogs are organized as tress with one or multiple root objects. Top-level nodes are called training groups (using SAP learning solution terminology). Training-groups are collections of multiple trainings of same order criteria. These criteria are based on the topic of the training, like Programming languages, Product knowledge, soft skills etc. Other criteria could be training forms, (classroom training, virtual classrooms, tests) or the location, language, target group, imparted or required qualification etc.

FIG. 1 shows a data model 10 of a Prior Art course catalog within a learning management system. This model 10 illustrates a training catalog that contains a number of training group levels. In this example, 12 and 14 are training groups in a tree within the training catalog tree 10. On the next level, a course catalog 10 has training types represented by 16 and 18. Training types contain the description of trainings, their schedule, price etc but not a date. They are like blueprints for training. The leaves of a training catalog are the available trainings. The trainings in this example are 20, 22, 24, and 26. Trainings are built from a training type and have a date. They redefine the data they inherit from their training type. Ever training has exactly one training type.

Prior Art systems as shown in this example only allow for communication and integration for users on the training level. Therefore a collaboration room 28 is only assigned to the users on the training level. These collaboration rooms 28 allow users in the same “class” to communicate with one another. This solution has proved inadequate as the complexity of the Learning Management Systems has increased and the rules and relationships between user and the LMS have also been expanded.

Therefore the interfacing and integrating techniques within a computer based Learning Management System have become increasingly outdated and lack sophistication.

### SUMMARY

Various embodiments of the present invention provide methods that allow for user integration on every level of the Learning Management System. In one embodiment, the invention is a method. The method includes receiving a request for action on a class from a user. The method also includes traversing a catalog to find rules related to the class. The method further includes checking status of the user against rules related to the class. The method also includes executing the action for the user in relation to the class.

In another embodiment, the invention is an apparatus. The apparatus includes a processor. The apparatus also includes a database, and the database includes data related to groups and related associations. The apparatus further includes a traverse module to traverse a graph of the groups and related associations of the database. The traverse module is implemented by the processor. The apparatus also includes a user status maintenance module. The user status maintenance module maintains a user status related to associations and groups. The user status module also associates the user with associations related to groups including the user. The user status module is implemented by the processor.

In yet another embodiment, the invention is also a method. The method includes receiving a message indicating a user is added to a group. The method further includes traversing a graph of data including data relating to the group. The method also includes accumulating a list of associations related to the group during the traversing. The method further includes associating the user with the associations of the list of associations.

It will be appreciated that the present invention is described below using specific examples that are not intended to limit the invention. The systems and methodology may be applied to a broad range of other computer applications and related devices or methods. Therefore these and other advantages of the present invention will become apparent to those skilled in the art upon a reading of the following detailed description and a study of the drawing figures.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 is a Prior Art data model of a training group within a learning management system.

FIG. 2 is a data model of a training group within a learning management system.

FIG. 3 is a data model of a training group within a learning management system.

FIG. 4 is a flow diagram illustrating a data retrieving process of one embodiment.

FIG. 5 is a flow diagram illustrating a class booking process of one embodiment.

FIG. 6 is a flow diagram illustrating a class canceling process of one embodiment.

FIG. 7 is a flow diagram illustrating a class completion process of one embodiment.

FIG. 8 is a flow diagram illustrating a policy assigning process of one embodiment.

FIG. 9 is a flow diagram illustrating a data retrieving process of one embodiment.

FIG. 10 is a block diagram of an embodiment of the learning management system.

FIG. 11 is a data model of a portal application within a learning management system.

FIG. 12 is a data model of portal applications within a learning management system.

FIG. 13 is a schematic diagram of an embodiment of the learning management system.

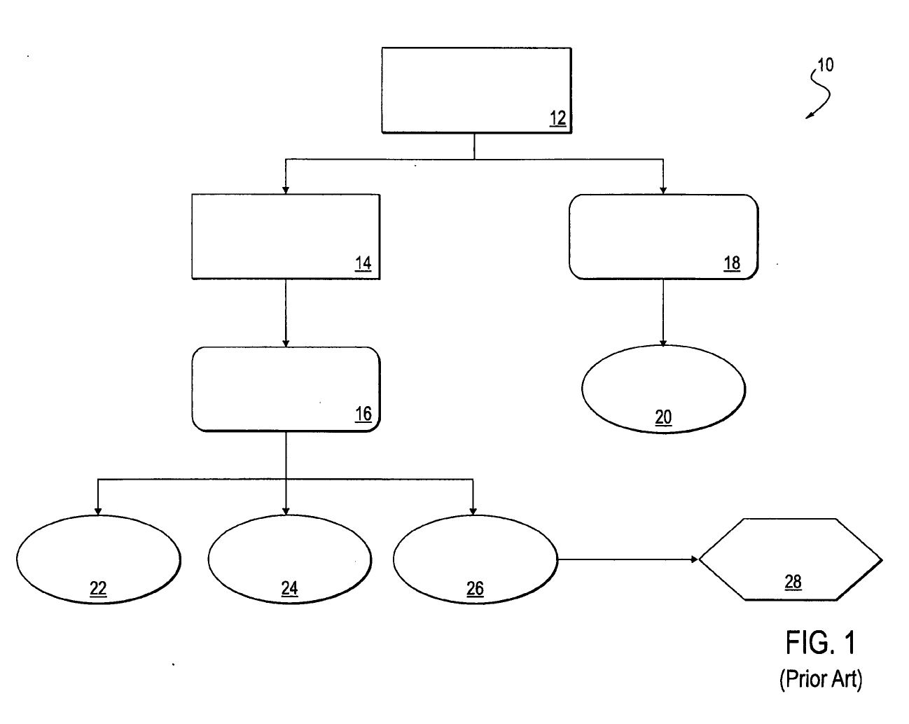

### DETAILED DESCRIPTION

Various embodiments of the present invention provide methods that allow for user integration on every level of the Learning Management System. Collaboration rooms can be assigned not only to trainings but to training groups and training types. Additionally, training groups, training types and trainings can contain multiple collaboration rooms and vice versa. A collaboration room can be assigned to multiple training groups, training types and trainings. In this manner customers have less administrative efforts when assigning to new collaboration rooms. The more common a collaboration room is used, the higher it is placed in the training catalog.

In another embodiment of the present system, a link is not only represented by a collaboration room. The links between data objects store a kind of policy for every business process. For example, there is a policy for booking and cancellation. Policies are actions or sets of actions the system should execute as a step in a business process, or a set of rules governing actions the system should execute. Policies include becoming a member and grant special authorization, remove authorization, remove membership etc. The links may provide synchronous and asynchronous collaboration tools, like chat-rooms, instant messaging and application sharing. This integration will extend the already shipped functionality with human-to-human interaction.

Various methods are provided that allow for each business process to be enacted by a user and further, the specific rules of each process may be customized by an administrator of the system. The various methods provide the user with the ability to create a relationship between training catalog entities and collaboration rooms, which are used for creating a set of objects. The methods use a business process dependent evaluation path to build these sets. The policies are used to define the actions executed on every item in this set. The set is a set of collaboration rooms or any other tools to be integrated into a LMS. For every business process on training like booking, the system uses an evaluation path to collect all objects and their corresponding collaboration rooms.

Another embodiment provides a system for enacting and enabling the various method of interaction with the learning system. Other embodiments of the present system provide a processor, a database, a traverse module and a user maintenance module that traverses graphs of the catalog, and updates and maintains a user's status and associations with respect to the data objects within the catalog.

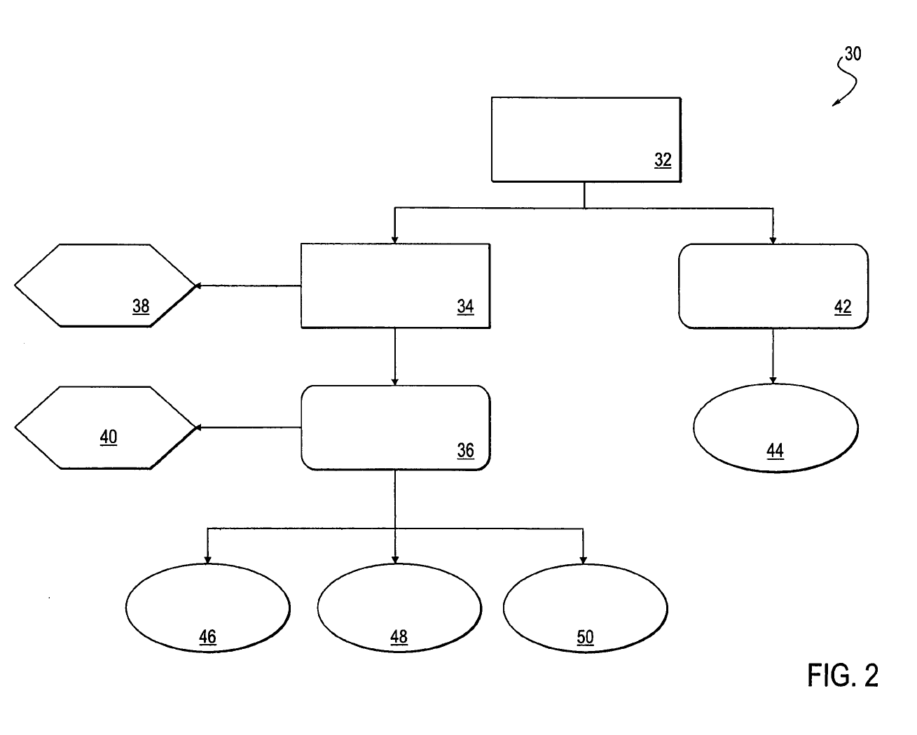

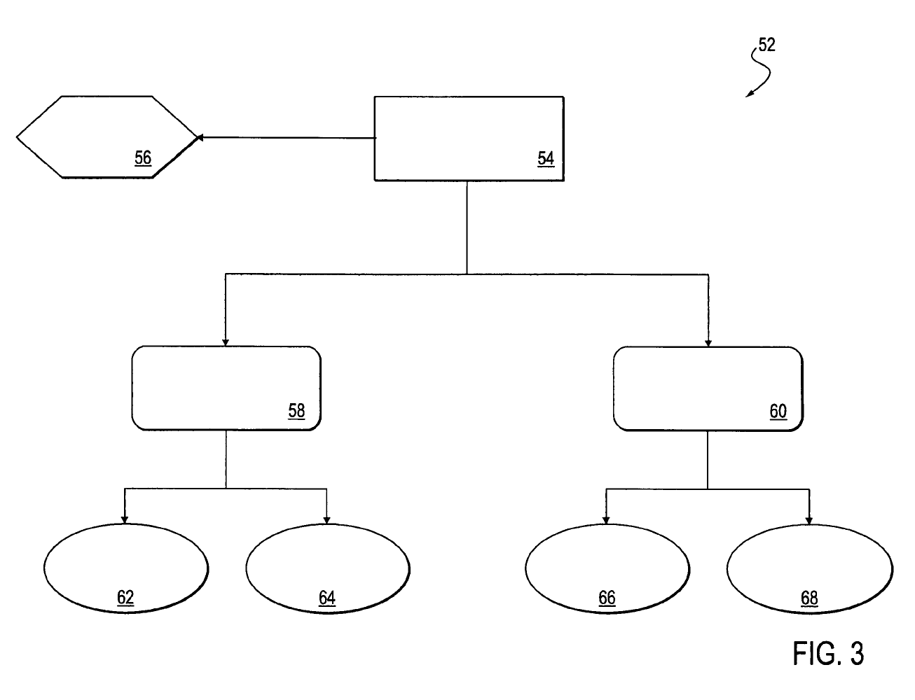

Various exemplary embodiments of the present system and methods are described below with reference to FIGS. 2-13. The present system offers integration on every level of a training catalog. The relationship between training catalog entities and collaboration rooms are used for creating a set of objects. The system uses a business process dependent evaluation path to build this set. The policies are used to define the actions executed on every item in this set. The set is a set of collaboration rooms or any other tools to be integrated into a LMS. FIGS. 2-3 show data models of training catalogs as described above.

FIG. 2 is an example of a data model 30 of a training group within a learning management system of an embodiment. In this example 32 and 34 are the training groups, and 36 and 42 represent training types. The available trainings are 44, 46, 48, and 50. The collaboration rooms 38 and 40 are available to those users with access to 34 and 36 respectively. For every business process on training like booking, the system uses an evaluation path to collect all objects and their corresponding collaboration rooms. For example, in FIG. 2 a learner may desire to register for training class 46. The system uses an evaluation path visiting all objects from the current leaf to the roof of the training catalog collecting training type 36 and training group 32 and 34. 34 and 36 contain links to collaboration rooms 38 and 40. As a result of the booking of training 46 the learner will be a member of both collaboration rooms 38 and 40.

Conflicting Information during booking can occur if for example 34 and 36 link to the same collaboration room with different booking policies, or if the learner is already a member of a collaboration room (with different authorizations).

The set of collaboration rooms built from the evaluation path is not a multi-set. If a collaboration room is linked to more than just one object of the training catalog, the evaluation path will use the deepest object in the training catalog as an anchor of this collaboration room and delete all other objects from the path, as the deepest objects is the most specific one. So it uses the following relationship training>training type>training group. The booking evaluation path also takes care of already existing memberships as it removes all collaboration rooms the learner is already participating.

FIG. 3 is another exemplary data model 52 of a training group within a learning management system. In this example the training group is 54 and the training types are 58 and 60. The available trainings are 62, 64, 66, and 68, while the collaboration room is 56. Cancellation is a good example of a more complex business process that requires a different evaluation path. For example a learner is booked on training 62 as shown in FIG. 3. The system will automatically create a membership for collaboration room 56 based on the link of training group 54. Later, the learner is booked on training 66. Training 66 belongs to training group 54 also. The membership for 56 already exists so the system will not create an action for collaboration room 56.

The present system is also able to handle a scenario where the learner cancels training 62. The system will use an evaluation path visiting all objects bottom-up from the training to the root training group. But in contrast to the booking evaluation path, it will use reference counting to find all active bookings belonging to collaboration room 56 and it will only execute the action if this counter is zero. In our example, the system reads all objects linking to collaboration room 56. The set of objects is {54}. Now it will to a top-down search to find all bookings of all trainings belonging to 54. It will first build the set {58, 60} of all training types and in the next step a set of all trainings {62, 64, 66, 68} of training types {58, 60}. As 62 is the training causing the action, 62 is removed from the set resulting in {64, 66, 68}. As the learner is booked in 68, the reference counter of 56 is 1 so the 56 membership is not removed and no action is executed.

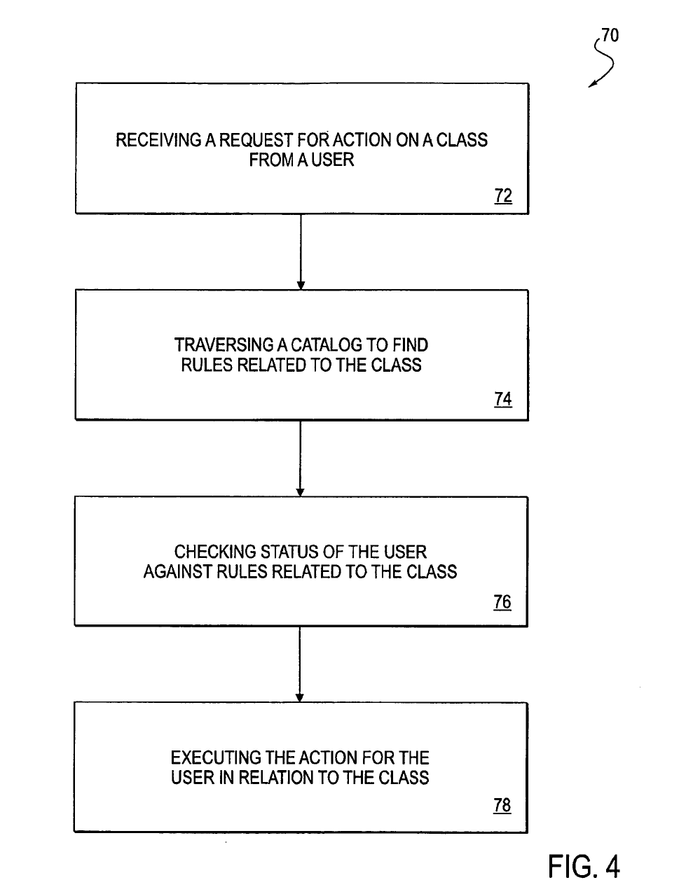

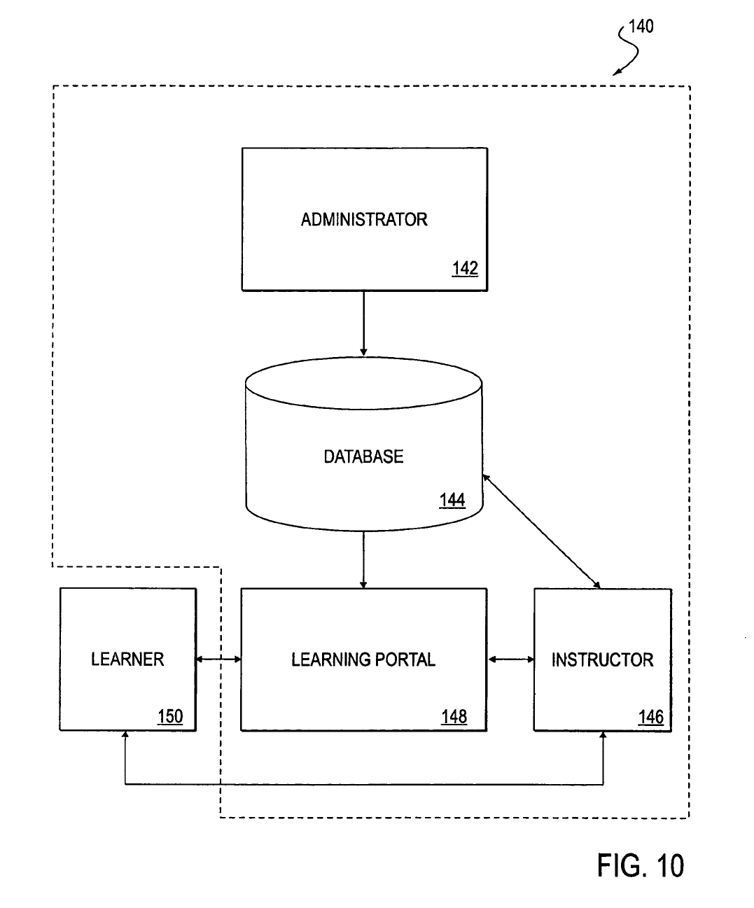

If the learner cancels 68, the system builds a set of trainings {64, 66}. Because the learner is not a participant in {64, 66} the system finally removes the 56 membership with the policy of 54. FIGS. 4-9 illustrate methods that navigate training catalogs as described in FIGS. 2-3, while FIGS. 10-13 describe the structures that enable the methods.

FIG. 4 is a flow diagram illustrating an exemplary process 70 enacted by the system to process a user's inputs and requests regarding classes in a LMS catalog. The process includes receiving a request, traversing a catalog, checking user status, and executing the action for the user. The process is illustrated as a set of modules which may be implemented or executed as parts of the process. Such modules may be parts of such a process, or may represent software modules or apparatus (e.g. hardware) modules in various embodiments, for example. Moreover, such modules may potentially be combined or subdivided, and may be reordered or may be organized in a parallel fashion in various embodiments for example.

The process begins at module 72 by receiving a request for action on a class from a user. At module 74 the module traverses a catalog to find rules related to the class. At module 76 the module checks the status of the user against rules related to the class. At module 78 the system executes the action for the user in relation to the class. As will be subsequently described, the rules for each class may be determined and entered by an administrator of the system. These rules will determine a user's status and associations with the classes and collaboration rooms for example.

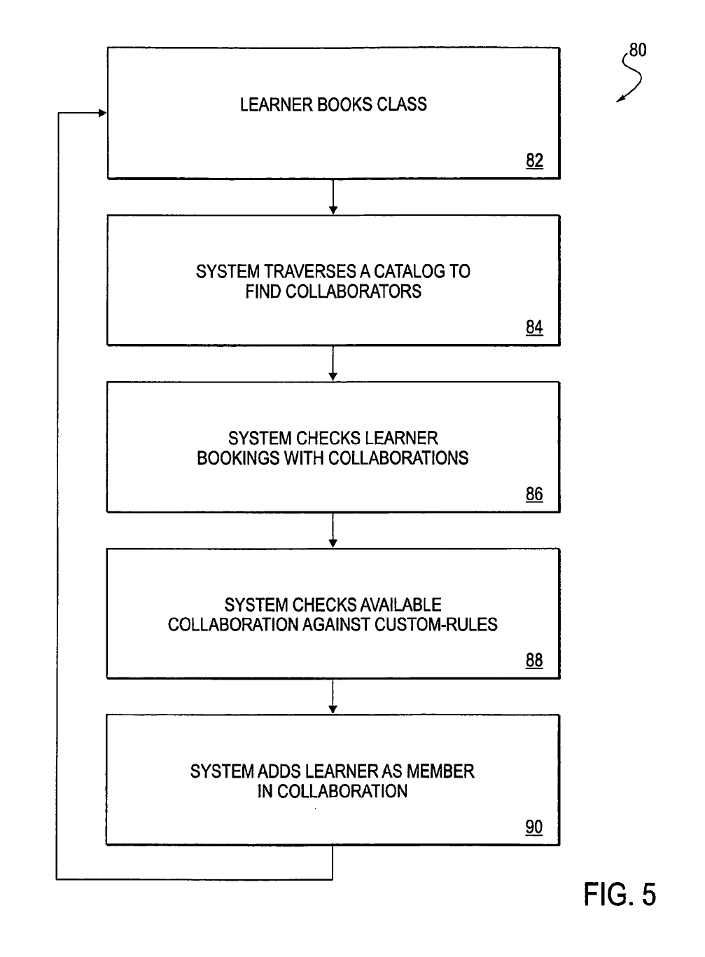

One example of an action available is booking a class. FIG. 5 is a flow diagram illustrating an exemplary process 80 enacted by the system to book a class desired by a user. The process includes receiving a booking, traversing a catalog, checking for collaborations, evaluating requirements of rules, and adding the user as a member of a collaboration.

The exemplary process starts at module 82 when a learner books a class. At module 84 the system traverses a catalog to find collaborations. At module 86 the system checks learner bookings with the collaborations. At module 88 the system checks available collaborations against custom rules. At module 90 the system adds the learner as a member in the collaborations. The process then returns to module 82 and awaits the next learner to book a class. This process allows the user to have access to specific collaboration tools based on the rules and user status within the LMS.

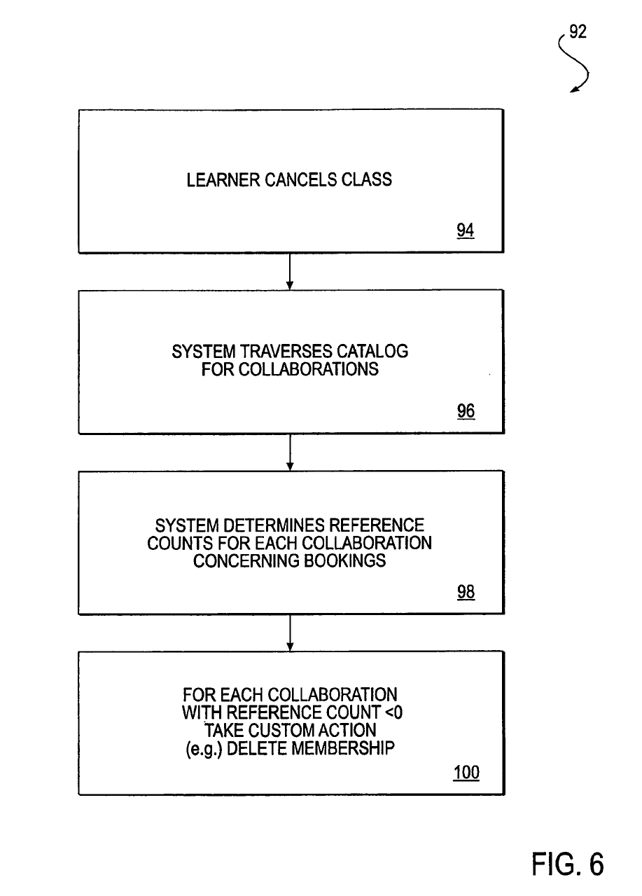

Another example of an action a user may take is cancellation. FIG. 6 is a flow diagram illustrating an exemplary process 92 enacted by the system to cancel a class at the request of a user. The process includes receiving a cancellation, traversing a catalog, determining reference counts for collaborations, checking for a zero reference count, and canceling a collaboration.

The exemplary process starts at module 94 when a learner cancels a class. At module 96 the system traverses a catalog to find collaborations. At module 98 the system determines reference counts for each collaboration concerning bookings. At module 100 the system checks for each collaboration with a reference count equal to zero, and if the when the reference count is nil, the custom action taken is to delete the learner's membership. This process allows the user to have access to certain collaborations even if they have cancelled a class.

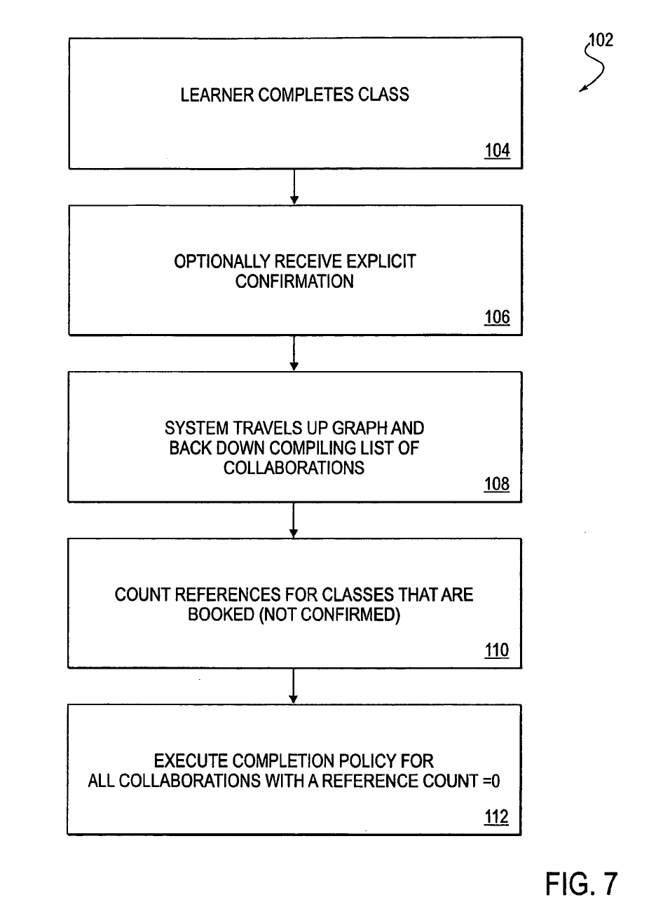

Yet another potential action is completion of a class. FIG. 7 is a flow diagram illustrating an exemplary process 102 enacted by the system when a user has completed a class. The process includes receiving an indication of completion of a class, traversing a catalog, counting references for collaborations, and executing a completion policy.

The exemplary process starts at module 104 when a learner completes a class. At module 106 the system may optionally receive explicit confirmation. At module 108 the system travels up and down a graph compiling a list of collaborations. At module 110 the system counts references for classes that are booked (not confirmed). At module 112 the system executes completion policy for all collaborations with a reference count of zero.

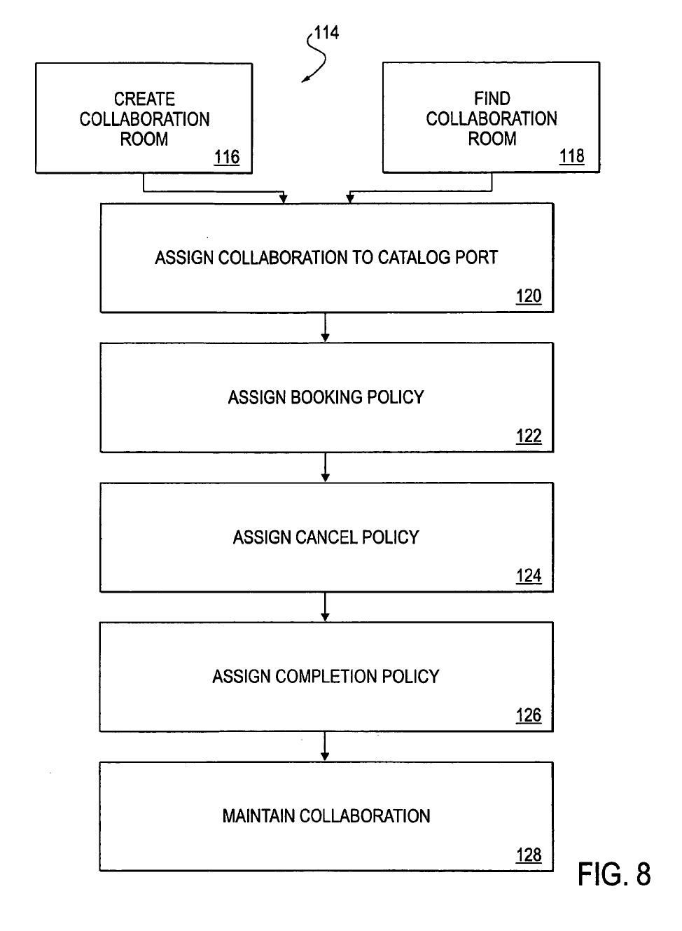

In relation to the catalogs of trainings or classes, administrators and other supervising users may define rules. FIG. 8 is a flow diagram illustrating an exemplary process 114 enacted by the system to allow administrators and instructors to define rules and policies for the processes of booking, canceling, and completion of classes as shown in FIGS. 4-7. The process includes starting with a collaboration room, assigning the collaboration to part of a catalog, assigning a booking policy, assigning a cancellation policy, and maintaining collaborations.

The exemplary process starts at modules 116 or 118 either by finding a collaboration room or creating a collaboration room. At module 120 the system assigned collaboration to a catalog port. At module 122 a booking policy is assigned. At module 124 a cancel policy is assigned. At module 126 a completion policy is assigned. At module 128 the system maintains collaborations. In this manner the rules and policies may be determined by an administrator and stored by the system. This allows for automatic processing when the user requests an action within the LMS.

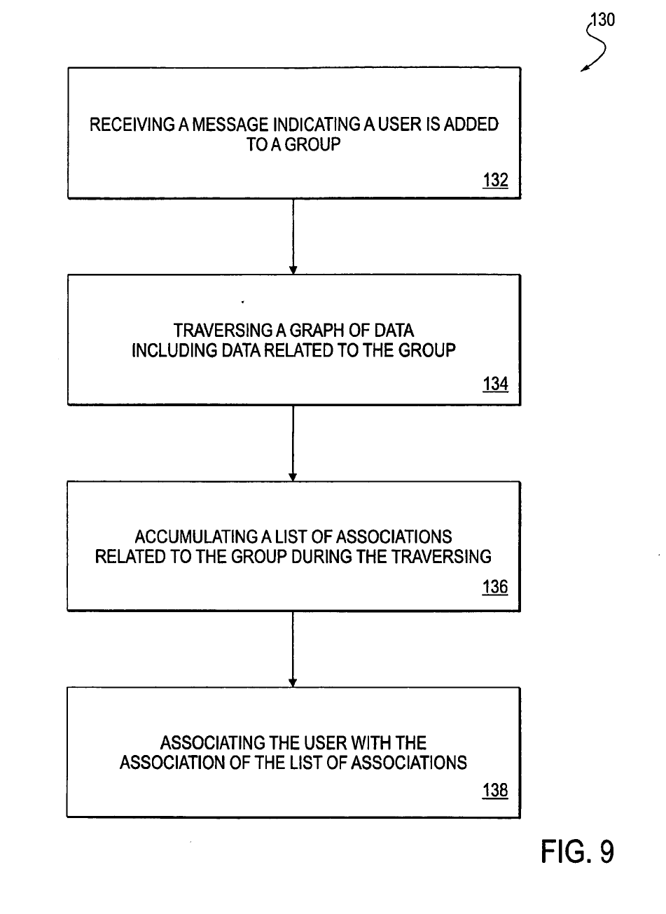

The processes may also be applied to other systems where a user may work within a group and gain certain privileges or options as a result. FIG. 9 is a flow diagram illustrating an exemplary process 130 enacted by the system. The process includes receiving notification of addition of a user to a group, traversing a graph related to the group, accumulating associations related to the group, and associating the user with associations related to the group.

The process begins at module 132 where a module receives a message indicating a user is added to a group. At module 134 the module traverses a graph of data including data relating to the group. At module 136 the system accumulates a list of associations related to the group during the traversing. At module 138 the system associates the user with the associations of the list of associations.

The various methods may be implemented in a variety of ways, including in conjunction with a computer or machine. FIG. 10 is a schematic diagram of an embodiment of a computer learning system 140 that can be used to support the exemplary methods as described above. The learning management system 140 supports three types of user roles, administrator 142, instructor 146 and learner 150. A computer user or learner 150 interacts with the system 140 through an interface portal 148 which would contain a conventional display, keyboard and mouse. A plurality of computer learners 150, may be connected to the system 140 as shown. A database 144 stores data relating to the catalog of classes within the learning management system 140 as well as other pertinent data. The database 144 may further contain program segments that embody the exemplary processes as described above. All the elements of the system 140 are connected by standard bus connections as shown.

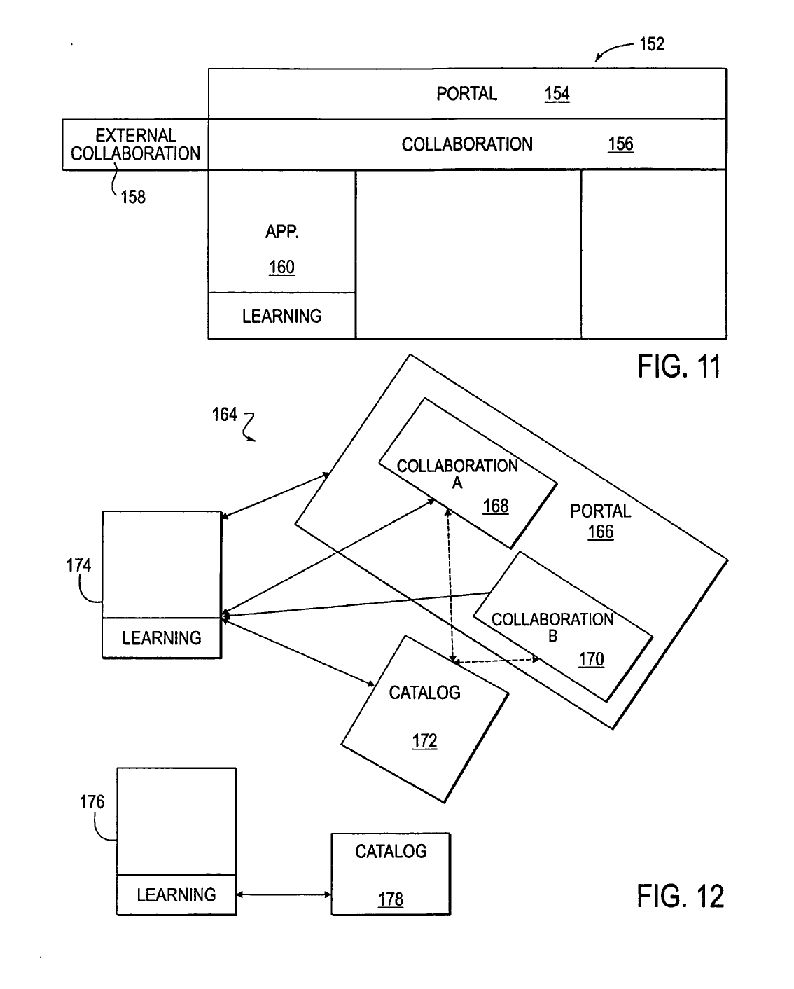

Various software architectures may be used in conjunction with the methods and apparatuses described above. FIG. 11 is a diagram of the portal environment within an embodiment of a computer learning system 152. In this figure the portal 154 is layered on software collaboration 156, an application 160 and learning system 162. External collaboration 158 exists outside the portal 154 as illustrated. Thus, internal collaboration or external collaboration facilities may be used with a portal and learning system such as portal 154 and learning system 162.

FIG. 12 is another example of a schematic diagram of the portal environment of a computer learning system 164. The portal 166 contains collaboration rooms A and B, 168 and 170 respectively. Both collaboration rooms are used with courses contained in catalog 172. The application and learning system 174 may be coupled or linked to both collaboration rooms 168 and 170, and also to the catalog 172. The application and learning system 176 is illustrated as linked to the catalog 178, as this linkage may be expected to be more persistent than potentially changing links between catalogs or learning systems and collaborations. For example, a collaboration facility may be superseded by a later collaboration facility, or may be reassigned (such as due to changes in course relationships or course structures for example).

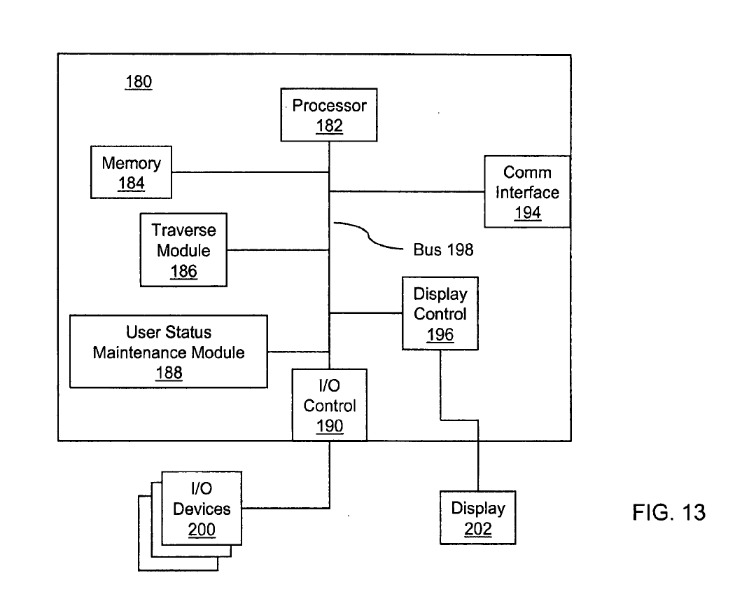

FIG. 13 is a schematic diagram of another embodiment of a computer system 180 that can be used to support the methods for interacting with a learning management system as described in FIGS. 4-9 above. The computer system 180 may interface to external systems through the modem or network interface 194. It will be appreciated that the modem or network interface 194 can be considered to be part of the computer system 180. This interface 194 can be an analog modem, ISDN modem, cable modem, token ring interface, satellite transmission interface (e.g. “Direct PC”), or other interfaces for coupling a computer system to other computer systems.

The exemplary computer system 180 includes a processor 182, which can be a conventional microprocessor such as an Intel Pentium microprocessor or Motorola Power PC microprocessor. A memory or database 184 is coupled to the processor 182 by a bus 198. Memory 184 can be dynamic random access memory (DRAM) and can also include static RAM (SRAM). The bus 198 couples the processor 182, the memory 184, the traverse module 186, the user status maintenance module 188, the display controller 196, and the input/output (I/O) controller 190 for operation. The processor 182 and the traverse module 186, the user status maintenance module 188, work together to enable and enact the methods. The algorithms and processes of the system 180 may be contained in computer programmed code segments as is conventional, for example. Moreover, the various modules may be integrated (such as by embodying modules 186 and 188 into memory 184 for example).

The display controller 196 controls the display device 202 from instructions received from the processor 182 and the memory 184 to provide the appropriate user interfaces for interaction and learning programs with the system 180. The input/output devices 200 can include a keyboard, disk drives, printers, a scanner, and other input and output devices, including a mouse or other pointing device. The display controller 196 and the I/O controller 190 can be implemented with conventional well-known technology to provide the customized user interface.

The non-volatile storage of data into the database memory 184 is often a magnetic hard disk, an optical disk, or another form of storage for large amounts of data. Some of this usage data is often written, by a direct memory access process, into memory 184 during execution of software in the computer system 180. One of skill in the art will immediately recognize that the terms “machine-readable medium” or “computer-readable medium” includes any type of storage device that is accessible by the processor 182 and also encompasses a carrier wave that encodes a data signal.

The exemplary computer system 180 is one example of many possible computer systems that have different architectures. For example, personal computers based on an Intel microprocessor often have multiple buses, one of which can be an input/output (I/O) bus for the peripherals and one that directly connects the processor 182 and the memory 184 (often referred to as a memory bus). The buses are connected together through bridge components that perform any necessary translation due to differing bus protocols.

Network computers do not usually include a hard disk or other mass storage, and the executable programs are loaded from a network connection into the memory 184 for execution by the processor 182. A Web TV system, which is known in the art, is also considered to be a computer system according to this embodiment, but it may lack some of the features shown in FIG. 13, such as certain input or output devices. A typical computer system will usually include at least a processor, memory, and a bus coupling the memory to the processor.

In addition to the processes, the exemplary computer system 180 is controlled by operating system software that includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the memory 184 and causes the processor 182 to execute the various acts required by the operating system to input and output data and to store data in memory, including storing files on the memory 184.

In this embodiment the LMS catalog of classes and the rules associated with each action with respect to the classes are stored in the database 184. When a user requests some type of action, the traverse module 186 accesses the database 184 to begin traversing the graph or tree within a training group. As described above with reference to FIGS. 4-9, the rules associated with each type of action are taken into account while the database is traversed. The user status module 188 then is able to update and maintain the user's new status and the appropriate associations and collaboration tools may be assigned to the user.

Some portions of the detailed description relating to the traverse module and user status maintenance module 186 and 188 have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to the apparatus for performing the operations herein. This apparatus may be specially constructed for the required purposes, or it may comprise a general purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein relating to the traverse module 186 and the user status maintenance module 188 are not inherently related to any particular computer or other apparatus. Various general purpose systems may be used with programs in accordance with the teachings herein, or it may prove convenient to construct more specialized apparatus to perform the required method modules. In addition, the present invention is not described with reference to any particular programming language, and various embodiments may thus be implemented using a variety of programming languages.

One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Accordingly, the invention is described by the appended claims.

What is claimed is:

1. A method comprising:
receiving a request for action on a class from a user;
traversing a catalog to find rules related to the class;
checking status of the user against rules related to the class; and
executing the action for the user in relation to the class.

2. A method as recited in claim 1 wherein the request for action is registering for a class.

3. A method as recited in claim 2 wherein the request for action is canceling a class.

4. A method as recited in claim 3 wherein the request for action is completing a class.

5. A method as recited in claim 4 wherein the rules relating to each class are determined by an administrator.

6. A method as recited in claim 5 wherein the rules for the actions of registering, canceling and completing a class are determined by an administrator.

7. A method as recited in claim 6 wherein executing the action includes registering the user to a collaboration room.

8. A method as recited in claim 6 wherein executing the action includes removing the user from a collaboration room.

9. A method as recited in claim 6 wherein executing the action includes providing a data link.

10. A method as recited in claim 1 wherein the method is embodied in a machine-readable medium as a set of instructions, the instructions, when executed by a processor, causing the processor to perform the method.

11. A method, comprising:
receiving a message indicating a user is added to a group;
traversing a graph of data including data relating to the group;
accumulating a list of associations related to the group during the traversing; and
associating the user with the associations of the list of associations.

12. A method as recited in claim 11 wherein the graph of data relates to classes within a learning management system.

13. A method as recited in claim 12 wherein the list of associations includes registering a user in a collaboration room.

14. A method as recited in claim 13 wherein the associations are determined by rules.

15. A method as recited in claim 14 wherein the rules are determined by business policies.

16. A method as recited in claim 15 wherein the rules are determined by an administrator.

17. An apparatus comprising:
a processor;
a database, wherein the database includes data related to groups and related associations;
a traverse module to traverse a graph of the groups and related associations of the database, the traverse module implemented by the processor; and;
a user status maintenance module, wherein the user status maintenance module maintains a user status related to associations and groups, wherein the user status module associates the user with associations related to groups including the user, wherein the user status module is implemented by the processor.

18. An apparatus as recited in claim 17 wherein the database includes a users' status with respect to a plurality of classes within a learning management system.

19. An apparatus as recited in claim 18 wherein the user status maintenance module updates the user's status when a user requests an action on a class.

20. An apparatus as recited in claim 19 wherein the associations include rules that determine the user's updated status.
